(19) United States
(12) Patent Application Publication
(10) Pub. No.: US 2011/0261907 A1
(43) Pub. Date: Oct. 27, 2011

(54) WIRELESS WAKE-UP SYSTEM AND OPERATION METHOD THEREOF

(75) Inventors: Kyoung Moon LEE, Busan (KR); Young Tak KIM, Busan (KR); Dong Seok KANG, Busan (KR); Young Chang KIM, Busan (KR); Ae Kyoung KO, Busan (KR); Jae Pyung KO, Yangsan-si (KR)

(73) Assignee: Dong-A University Research Foundation For Industry -Academy Cooperation, Busan (KR)

(21) Appl. No.: 12/969,208

(22) Filed: Dec. 15, 2010

(30) Foreign Application Priority Data
Apr. 23, 2010 (KR) 10-2010-0037844

(51) Int. Cl. H04L 27/06

(52) U.S. Cl. 375/340

(57) ABSTRACT

A wireless wake-up system and an operation method thereof are provided to optimize power consumption when wireless data is received. The wireless wake-up system activates a wake-up detection module and then compares a wireless input signal received through an antenna with a pre-stored reference value. If the wireless input signal is equal to the reference value, the wireless wake-up system determines that the input signal is a wake-up signal with a low bit rate, and then generates a wake-up command corresponding to the wake-up signal. Also, the wireless wake-up system activates a selected module kept in an inactive state by sending the wake-up command to the selected module. The activated module may be a microcontroller unit (MCU). When the MCU is activated, the wireless wake-up system may inactivate the wake-up detection module.

### BACKGROUND OF THE INVENTION

1. Field of the Invention

The present invention relates to a wireless wake-up system and an operation method thereof both of which can optimize power consumption when wireless data is received.

2. Description of the Related Art

With wireless communications advanced dramatically, there appears an evolved network based on a fixed-mobile convergence in a variety of fields. Additionally, to meet such convergence environments, many kinds of wireless standards have been introduced in these days. Moreover, related modern technologies are evolving toward a direction of providing a low-speed, a low-price and a low-power as well as a direction of offering a high-speed and a high-power.

Based on wireless communication technologies with a low-speed and a low-power, a wake-up device has been developed. The wake-up device activates a main transceiver, only for the purpose of a communication, which is normally kept in the off state. Therefore, the wake-up device can reduce power consumption and increase a battery life. A representative one of the wake-up devices is a car alarm system.

Unfortunately, this system may usually remain in the active state, while continuously consuming the power. So, this system may frequently require a replacement of a battery, causing inconvenience to a user. In particular, a remote controller for vehicles needs some components such as an RF receiver and a CPU that should be activated to receive data. Hence there occurs much greater power consumption.

### BRIEF SUMMARY OF THE INVENTION

Accordingly, the present invention is to address the above-mentioned problems and/or disadvantages and to offer at least the advantages described below.

An aspect of the present invention is to provide a wireless wake-up system and an operation method thereof both of which can minimize power consumption by detecting a wake-up signal with a low bit rate of transmission data while effectively supplying electric power to respective modules of the system.

According to one aspect of the present invention, provided is a wireless wake-up system that comprises an antenna and a wake-up detection module. The antenna is configured to receive a wireless signal. The wake-up detection module is configured to compare the received signal with a pre-stored reference value in order to determine whether the signal is a wake-up signal with a low bit rate, to generate a wake-up command corresponding to the wake-up signal, and to send the wake-up command to a selected module kept in an inactive state.

The system may further comprise at least one of a microcontroller unit (MCU), a radio frequency (RF) receiver, and an RF transmitter. The MCU is configured to be changed from the inactive state to an active state when receiving the wake-up command from the wake-up detection module. The RF receiver is configured to be activated under the control of the MCU, to perform a demodulation and decoding of a wireless data signal received by the antenna, and to send the decoded signal to the MCU. The RF transmitter is connected to the antenna and is configured to send a signal to the outside.

In the system, at least two of the RF receiver, the RF transmitter and the wake-up detection module may be formed in a single integrated chip.

In the system, wherein the wake-up detection module may includes an amplifier configured to amplify the signal received by the antenna, a detector configured to detect the amplified signal, an analog-to-digital convertor (ADC) configured to convert the detected analog signal to a digital signal, and a wake-up controller configured to compare the digital signal with the reference value and then to generate the wake-up command according to comparison results.

In the system, wherein the wake-up controller may includes at least one reference register each configured to store at least one reference value, a shift register configured to store an output signal of the ADC, at least one comparator configured to compare the reference value stored in the at least one reference register and a value stored in the shift register, and a wake-up generator configured to generate at least one kind of the wake-up command according to comparison results of the at least one comparator.

In the system, the wake-up system may be composed of two or more chips each of which is separately activated and driven in response to the wake-up command.

In the system, the wake-up detection module may be further configured to adjust a sampling bit rate of the wake-up signal to 1˜4 msec according to external inputs.

According to another aspect of the present invention, provided is a method for operating a wireless wake-up system. The method comprises steps of activating a wake-up detection module; comparing a wireless input signal received through an antenna with a pre-stored reference value; if the wireless input signal is equal to the reference value, determining that the input signal is a wake-up signal with a low bit rate and then generating a wake-up command corresponding to the wake-up signal; and activating a selected module kept in an inactive state by sending the wake-up command to the selected module.

In the method, the activated module may include a microcontroller unit (MCU).

The method may further comprise at least one of steps of inactivating the wake-up detection module when the MCU is activated; and activating a radio frequency (RF) receiver connected to the MCU, performing a demodulation and decoding of a wireless data signal received by the antenna in the RF receiver, and processing the decoded data signal in the RF receiver.

The method may further comprise at least one of steps of activating the wake-up detection module when the data signal processing is completed; and inactivating at least one of the MCU and the RF receiver.

In the method, the step of generating the wake-up command may include comparing the wireless input signal with two or more reference values; and if the wireless input signal corresponds to a particular one of the reference values, generating the wake-up command corresponding to the particular reference value.

According to aspects of the present invention, it is possible to minimize power consumption through transmission and reception of data with a lower bit rate. Additionally, a simpler data processing may realize a simpler structured device. Also, in case of a bidirectional alarm remote controller or receiving a car wireless communication, battery consumption may be considerably reduced and thereby a battery life may be favorably increased.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram illustrating a wireless wake-up system in accordance with an exemplary embodiment of the present invention.

FIG. 2 is a view illustrating the configuration of a wake-up controller in accordance with an exemplary embodiment of the present invention.

FIG. 3 is a view illustrating the configuration of a wake-up controller in accordance with another exemplary embodiment of the present invention.

FIG. 4 is a view illustrating a wake-up signal pattern and a time cycle in accordance with an exemplary embodiment of the present invention.

FIG. 5 is a flow diagram illustrating an operating method of a wake-up system in accordance with an exemplary embodiment of the present invention.

### DETAILED DESCRIPTION OF THE INVENTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

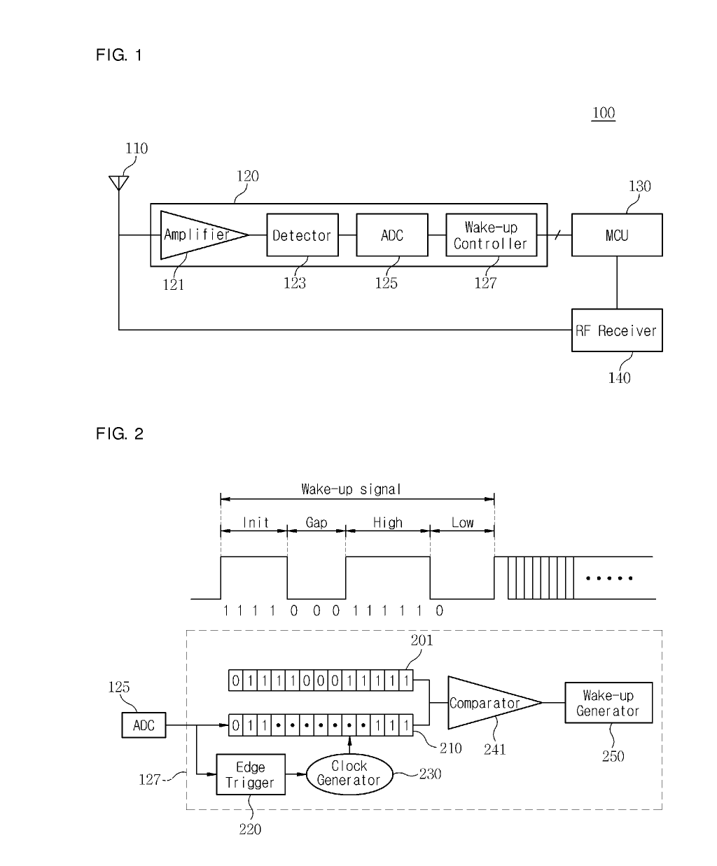

FIG. 1 is a block diagram illustrating a wireless wake-up system in accordance with an exemplary embodiment of the present invention. Hereinafter, the wireless wake-up system will be generally described as applied to vehicles. This is, however, exemplary only and not to be considered as a limitation of this invention. The wireless wake-up system of this invention may also be applied to any other electronic equipment.

Referring to FIG. 1, the wireless wake-up system 100 includes an antenna 110, a wake-up detection module 120, a microcontroller unit (MCU) 130, and a radio frequency (RF) receiver 140.

The wireless wake-up system 100 having the above elements keeps the wake-up detection module 120 only in an active state, while keeping both the MCU 130 and the RF receiver 140 in an inactive state. Therefore, the wireless wake-up system 100 can minimize an electric current consumed by both the MCU 130 and the RF receiver 140 before the generation of a wake-up signal. Also, when the wake-up detection module 120 detects a wake-up signal, the wireless wake-up system 100 activates both the MCU 130 and the RF receiver 140 and then receives data, while keeping the wake-up detection module 120 in an inactive state. Therefore, the wireless wake-up system 100 can minimize an electric current consumed by the wake-up detection module 120. In this process, by adjusting a bit rate of data used, the wireless wake-up system 100 can reduce power consumption. Additionally, when receiving data is ended, the wireless wake-up system 100 returns the wake-up detection module 120 only to an active state, and also returns both the MCU 130 and the RF receiver 140 to an inactive state. Now, respective elements are described hereinafter in detail.

The antenna 110 is a metallic apparatus for receiving a wake-up signal and data and is designed to cover a frequency band capable of sending and receiving the wake-up signal and data. For instance, the antenna 110 may be fabricated in a suitable form for covering a frequency range of 300 MHz to 450 MHz. The antenna 110 is also coupled to the RF receiver 140 and hence supports a data reception of the RF receiver 140. If the wireless wake-up system 100 includes an RF transmitter, the antenna 110 may also perform data transmission by sending a signal of the RF transmitter in the air.

The wake-up detection module 120 is coupled to the antenna 110 and ascertains whether a predefined wake-up signal is included in signals received by the antenna 110. If the predefined wake-up signal is included, the wake-up detection module 120 generates a wake-up command to wake up the MCU 130 and then sends the generated wake-up command to the MCU 130. As shown, the wake-up detection module 120 may include an amplifier 121, a detector 123, an analog-to-digital converter (ADC) 125, and a wake-up controller 127.

The amplifier 121 is configured to amplify a signal received by the antenna 110. Specifically, the amplifier 121 amplifies the received signal, depending on its own performance, and then sends the amplified signal to the detector 123. Namely, the amplifier 121 can amplify a signal with a low sensitivity in a wireless signal reception environment so that the detector 123 may appropriately detect the signal.

The detector 123 is configured to detect an analog signal sent by the amplifier 121 and to send the detected analog signal to the ADC 125. The detector 123 can extract an analog signal only having a certain form among the received signal and also remove a noise.

The ADC 125 is configured to convert the signal detected by the detector 123 into a digital signal. The ADC 125 can determine whether a currently inputted analog signal is in a high state or in a low state through amplitude variations, etc. of the signal sent by the detector 123 and then, depending on the determined state, set the value (i.e., “1” or “0”) of a digital signal.

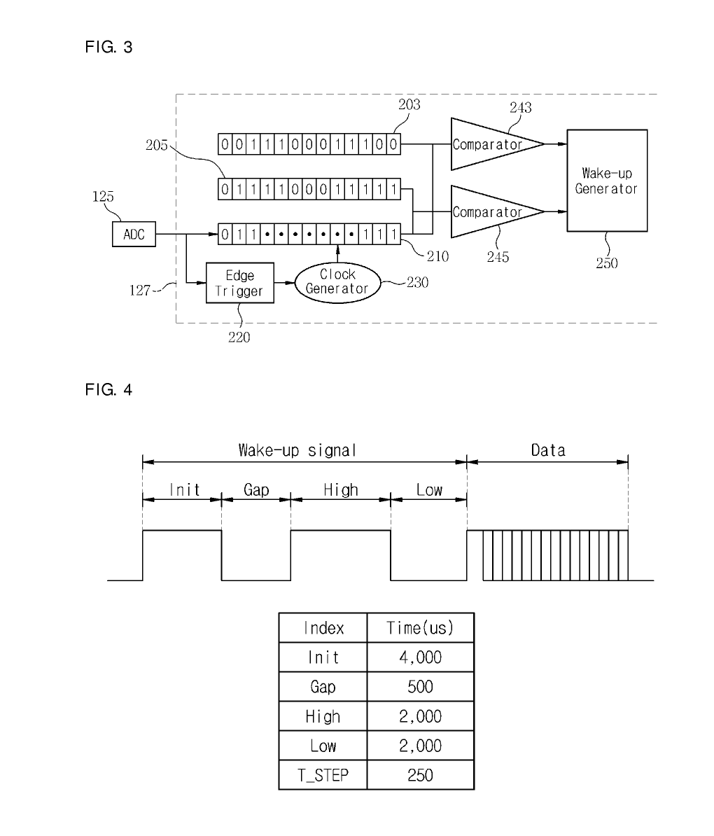

The wake-up controller 127 compares the digital signal sent by the ADC 125 with a predefined reference value. Then, depending on comparison results, the wake-up controller 127 can generate a wake-up command to wake up the MCU 130 and then send the generated wake-up command to the MCU 130. For this, the wake-up controller 127 may include a reference register for storing the predefined reference value, a shift register for storing the digital signal value offered by the ADC 125, a comparator for comparing both values stored in the reference register and the shift register, and a wake-up generator for generating the wake-up command according to comparison results. The detection of a wake-up signal and the generation of the wake-up command in the wake-up controller 127 will be described later in detail with reference to FIGS. 2 and 3.

In case of a vehicle, the MCU 130 may correspond to a central processing unit that performs the whole electronic control of the vehicle. Namely, the MCU 130 set forth herein is considered as a microcontroller unit or any other equivalent. The MCU 130 is normally kept in an inactive state and, when receiving a wake-up command from the wake-up detection module 120, is changed from the inactive state to an active state. After entering into the active state, the MCU 130 may perform a particular function to activate the RF receiver 140. In addition, when the RF receiver 140 is activated and then receives data, the MCU 130 may perform a data processing for data received by the RF receiver 140. After a data reception is completed, the MCU 130 is returned to the inactive state and may control the RF receiver 140 so that the RF receiver 140 may be also returned to the inactive state. Additionally, the MCU 130 may inactivate the wake-up detection module 120 when receiving the wake-up command and may also activate the wake-up detection module 120 when finishing the data processing. As discussed, the MCU 130 is activated only when receiving the wake-up signal and then performs a wireless data reception and processing. Also, when the data processing is completed, the MCU 130 is returned to the inactive state. Therefore, the MCU 130 can minimize power consumption.

The RF receiver 140 is configured to be activated or inactivated under the control of the MCU 130. Specifically, the RF receiver 140 is activated when receiving a control signal for activation from the MCU 130, performs a demodulation and decoding for a signal received by the antenna 110, and then sends the decoded signal to the MCU 130. Additionally, the RF receiver 140 may be returned to the inactive state under the control of the MCU 130. Since the RF receiver 140 is activated only while the MCU 130 processes data, the RF receiver 140 can also minimize power consumption.

As discussed heretofore, the wireless wake-up system 100 according to an embodiment of this invention normally activates only the wake-up detection module 120 for receiving the wake-up signal and therefore can save power to be consumed by both the MCU 130 and the RF receiver 140 during a waiting time for receiving the wake-up signal. Also, the wireless wake-up system 100 inactivates the wake-up detection module 120 after receiving the wake-up signal and therefore can save power to be required for operation of the wake-up detection module 120.

FIG. 2 is a view illustrating the configuration of a wake-up controller in accordance with an exemplary embodiment of the present invention.

Referring to FIGS. 1 and 2, a wake-up signal is received by the antenna 110 and then delivered to the ADC 125 through the amplifier 121 and the detector 123. Then the ADC 125 offers a digital signal to the wake-up controller 127.

Meanwhile, the wake-up controller 127 has an edge trigger 220 that is connected to the output of the ADC 125. Therefore, an output signal of the ADC 125 is delivered to the edge trigger 220 as well as a shift register 210. Additionally, the wake-up controller 127 further has a clock generator 230 that is disposed so that the output of the edge trigger 220 may be delivered to the clock generator 230 and also the output of the clock generator 230 may control the shift register 210. Therefore, when a digital signal is transmitted from the ADC 125, the wake-up controller 127 resets the clock generator 230 by the edge trigger 220 and performs a sampling of a signal outputted by the ADC 125. By the way, this signal may be inputted simultaneously with a reset of the clock generator 230 and thereby a sampling of a signal inputted during a reset of the clock generator 230 may not be performed. Therefore, if a state triggered by the edge trigger 220 is a rising edge, it may be designed to consider a signal inputted from the ADC 125 as a high signal “1” and then to store a subsequent sampling value in the shift register 210. If a state triggered by the edge trigger 220 is a falling edge, it may be designed to consider a signal inputted from the ADC 125 as a low signal “0” and then to sequentially store a subsequent sampling value in the shift register 210.

For instance, a wake-up signal timing diagram contains an Init field, a Gap field, and a High field as shown. The Init field is formed of four high values (i.e., “1” bits), the Gap field is formed of three low values (i.e., “0” bits), and the High field is formed of five “1” bits. In order to detect the wake-up signal (namely, a signal containing the Init field, the Gap field, and the High field), a reference register 201 of the wake-up controller 127 may store a value corresponding to the above-stated value, namely, “0111100011111”. Also, when the wake-up controller 127 receives the wake-up signal, the ADC 125 outputs “0111100011111” to the shift register 210, and then the shift register 210 stores “011 . . . 111” from the left because of a reset time of the clock generator 230 as shown. Therefore, a comparator 241 checks whether left three bit values in the shift register 210 are identical to right three bit values and, depending on check results, can determine whether the wake-up signal is received. Meanwhile, in case where the state of a signal outputted from the ADC 125 is determined to be high or low according to a triggered state of the edge trigger 220, the shift register 210 may store signals corresponding to the triggered state. Also, in case where a normal wake-up signal is received, the shift register 210 may store values having the same bit values as those stored in the reference register 201. In this case, the comparator 241 compares total values of the shift register 210 and the reference register 201 and, depending on comparison results, can determine whether the wake-up signal is received.

Meanwhile, if sampling values are stored in the shift register 210, the wake-up controller 127 can compare a value stored in the shift register 210 and a value stored in the reference register 201 through the comparator 241. If the output of the comparator 241 indicates that both values are equal to each other, the wake-up controller 127 may control the generation and output of the wake-up command, being based on a wake-up generator 250. The wake-up command is delivered to the MCU 130, and the MCU 130 is changed from the inactive state to the active state when receiving the wake-up command.

FIG. 3 is a view illustrating the configuration of a wake-up controller in accordance with another exemplary embodiment of the present invention.

Referring to FIG. 3, the wake-up controller 127 of this embodiment includes the first reference register 203, the second reference register 205, the shift register 210, the edge trigger 220, the clock generator 230, the first comparator 243, the second comparator 245, and the wake-up generator 250.

The wake-up controller 127 having the above elements stores separate reference values in the first and second reference registers 203 and 205, respectively, and thereby may generate separate wake-up commands when receiving different wake-up signals. Specifically, when the ADC 125 converts an analog signal into a digital signal and then delivers it to the shift register 210, the digital signal is recorded in the shift register 210 of the wake-up controller 127. Here, as discussed earlier in FIG. 2, an output signal of the ADC 125 is sent to the edge trigger 220, and then the output of the edge trigger 220 is delivered to the clock generator 230. Meanwhile, the clock generator 230 may be reset according to the output of the edge trigger 220 and also controls the shift register 210. Therefore, when a digital signal is transmitted from the ADC 125, the wake-up controller 127 resets the clock generator 230 by the edge trigger 220 and performs a sampling of a signal outputted by the ADC 125. This signal may be inputted simultaneously with a reset of the clock generator 230 and thereby a sampling of a signal inputted during a reset of the clock generator 230 may not be performed. Therefore, if a state triggered by the edge trigger 220 is a rising edge, it may be designed to consider a signal inputted from the ADC 125 as a high signal “1” and then to store a subsequent sampling value in the shift register 210. If a state triggered by the edge trigger 220 is a falling edge, it may be designed to consider a signal inputted from the ADC 125 as a low signal “0” and then to sequentially store a subsequent sampling value in the shift register 210. As a result, signals outputted from the ADC 125 are sequentially stored in the shift register 210 and thereby, as shown, values “011 . . . 111” may be recorded from the left in the shift register 210. These values recorded in the shift register 210 may be delivered to the first and second comparators 243 and 245 along connected signal lines.

Meanwhile, the first reference register 203 may store predefined bit values “0011100011100”, and the second reference register 205 may store predefined bit values “0111100011111”. These values respectively recorded in the first and second reference registers 203 and 205 correspond to wake-up signals that are predefined. Also, such values stored in the first and second reference registers 203 and 205 may be delivered to the first and second comparators 243 and 245, respectively.

As a result, when the output of the ADC 125 is recorded in the shift register 210, the values stored in the shift register 210 may be compared with the values stored in the first and second reference registers 203 and 205. If the value stored in the shift register 210 is equal to the value stored in the first reference register 203, the first comparator 243 may output the corresponding value to the wake-up generator 250. Also, if the value stored in the shift register 210 is equal to the value stored in the second reference register 205, the second comparator 245 may output the corresponding value to the wake-up generator 250.

The wake-up generator 250 receives a specific output from the first or second comparator 243 or 245 and then, depending on the received output, may generate different wake-up commands. Also, the wake-up generator 250 may send the generated wake-up commands to the MCU 130. Here, the different wake-up commands (i.e., the first and second wake-up commands) generated by the wake-up generator 250 may be applied in various manners according to the configuration of the system. For instance, if the system is designed to drive different modules in response to each wake-up command, the system may drive a selected module only depending on the type of wake-up command, thus reducing power consumption in comparison with case of activation of all modules. Namely, if the MCU 130 is connected to a vehicle starter module as well as the RF receiver 140, the system may be designed to enable the RF receiver 140 in response to the first wake-up command and to enable the vehicle starter module in response to the second wake-up command.

Although the above discussion is for case of using the first and second reference registers 203 and 205 storing two kinds of reference values, this is exemplary only and not to be considered as a limitation of this invention. Alternatively, the wake-up controller 127 of this invention may include much more reference registers and hence may have much more comparators. Also, if the wireless wake-up system 100 is composed of several chips, it is possible to separately activate each individual chip in response to each corresponding wake-up command. Moreover, this invention is not limited to the above-discussed case in which the wake-up command of the wake-up generator 250 is offered to the MCU 130. Alternatively, the wake-up command may be directly provided to each individual module that selectively requires the wake-up command.

FIG. 4 is a view illustrating a wake-up signal pattern and a time cycle in accordance with an exemplary embodiment of the present invention.

Referring to FIG. 4, a designer or user of the wireless wake-up system can change a sampling time (T_STEP) of a wake-up signal pattern by adjusting the register of the sampling time. Namely, a system designer or user can freely adjust the sampling time within a permissible range, e.g., from 0.5 msec to 2.5 msec. In addition, it is possible to adjust the lengths of the Init field, the Gap field and the High field in the wake-up signal timing diagram. Consequently, a system designer or user can freely change the setting of a header data format in the wake-up system. For instance, when the sampling time is adjusted to 0.5 msec and also the number of total bits constituting the Init field, the Gap field and the High field is reduced to a certain number, it is possible to form the entire wake-up signal in 1˜4 msec. In this case, the wireless wake-up system of this invention can considerably reduce a data bit rate of the wake-up signal and thereby can minimize an electric current consumed in a signal reception and processing. Additionally, by reducing a data bit rate of the wake-up signal, the wireless wake-up system of this invention can realize a much simpler configuration of various elements.

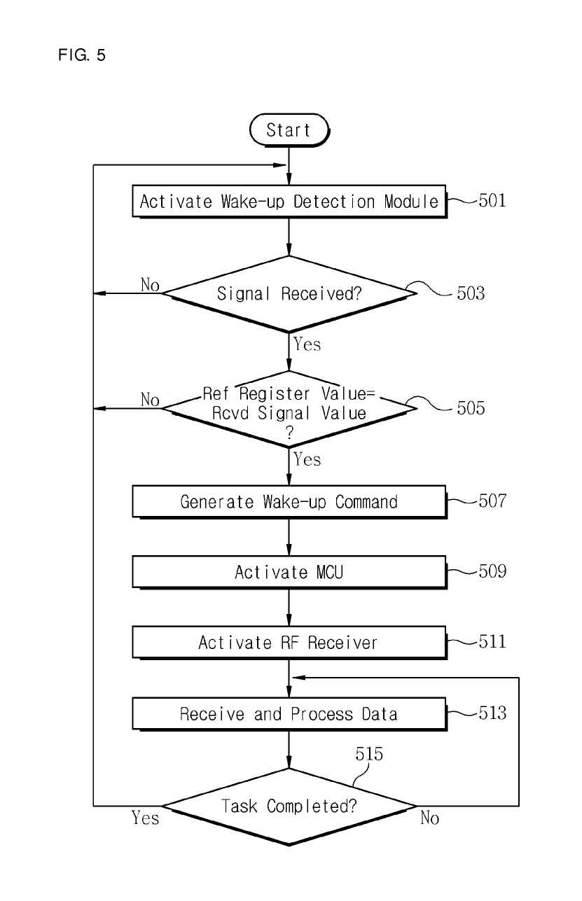

FIG. 5 is a flow diagram illustrating an operating method of a wake-up system in accordance with an exemplary embodiment of the present invention.

Referring to FIG. 5, at the outset, the wireless wake-up system may activate the wake-up detection module 120 only, while inactivating both the MCU 130 and the RF receiver 140 (step 501). In this state, if a wake-up signal is generated in the outside, the antenna 110 receives the wake-up signal and then delivers it to the wake-up detection module 120. Namely, the wake-up detection module 120 may check whether a particular signal is received from the outside (step 503). If no input signal is generated in the step 503, the wake-up detection module 120 returns to the previous step 501.

If the particular signal is received in the step 503, the wake-up detection module 120 compares the received signal with a pre-stored value in the reference register 201 (step 505). For this process, the wake-up detection module 120 detects the received signal, converts a corresponding analog signal into a digital signal, and stores the digital signal in the shift register 210. Then the wake-up detection module 120 compares a value stored in the shift register 210 and a value stored in the reference register 201.

If the values stored in the shift register 210 and the reference register 201 are not equal to each other in the step 505, the wake-up detection module 120 determines that the inputted signal is not the wake-up signal. Then the wake-up detection module 120 returns to the previous step 501.

If the values stored in the shift register 210 and the reference register 201 are equal to each other in the step 505, the wake-up detection module 120 determines that the received signal is the wake-up signal, and then generates a wake-up command (step 507). Also, the wake-up detection module 120 sends the wake-up command to the MCU 130.

Then the MCU 130 is changed from the inactive state to the active state in response to the wake-up command (step 509). Additionally, the MCU 130 controls the RF receiver 140 so that the RF receiver 140 may be changed from the inactive state to the active state (step 511). In this step, the MCU 130 inactivates the wake-up detection module 120, thus preventing power consumption by the wake-up detection module 120.

The activated RF receiver 140 receives wireless data inputted through the antenna 110, performs a demodulation and decoding of the received data, and sends the decoded data to the MCU 130 (step 513). Then the MCU performs various tasks according to the received data signal.

Meanwhile, the MCU 130 determines whether a selected task according to the data signal is completed (step 515). If the task is completed, the MCU 130 activates again the wake-up detection module 120. Namely, the MCU 130 returns to the previous step 501.

As fully discussed hereinbefore, the operating method of the wake-up system according to an embodiment of this invention allows the wake-up detection module 120 only to be kept in the active state and also allows both the MCU 130 and the RF receiver 140 to be kept in the inactive state. Therefore, power consumption is reduced. Additionally, when the wake-up signal is received, this method allows both the MCU 130 and the RF receiver 140 to be activated and also allows the wake-up detection module 120 to be inactivated. Therefore, power consumption is further reduced.

Although the wake-up detection module 120 and the RF receiver 140 are described above as separate elements, this invention is not limited to that. Alternatively, the wake-up detection module 120 and the RF receiver 140 may be formed in a single integrated chip and, in this case, the wake-up command generated by the wake-up detection module 120 may be directly offered to the RF receiver 140. Consequently, when the wake-up detection module 120 receives the wake-up signal, the RF receiver 140 is changed from the inactive state to the active state, and the wake-up detection module 120 is changed from the active state to the inactive state. Meanwhile, the wake-up system of this invention may further an RF transmitter not illustrated herein. In this case, the RF transmitter may be formed in a single integrated chip together with the wake-up detection module 120 and the RF receiver 140. The RF transmitter may be also controlled depending on the wake-up command of the wake-up detection module 120.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A wireless wake-up system comprising:
an antenna configured to receive a wireless signal; and
a wake-up detection module configured to compare the received signal with a pre-stored reference value in order to determine whether the signal is a wake-up signal with a low bit rate, to generate a wake-up command corresponding to the wake-up signal, and to send the wake-up command to a selected module kept in an inactive state.

2. The system of claim 1, further comprising at least one of:
a microcontroller unit (MCU) configured to be changed from the inactive state to an active state when receiving the wake-up command from the wake-up detection module;
a radio frequency (RF) receiver configured to be activated under the control of the MCU, to perform a demodulation and decoding of a wireless data signal received by the antenna, and to send the decoded signal to the MCU; and
an RF transmitter connected to the antenna and configured to send a signal to the outside.

3. The system of claim 2, wherein at least two of the RF receiver, the RF transmitter and the wake-up detection module are formed in a single integrated chip.

4. The system of claim 1, wherein the wake-up detection module includes:
an amplifier configured to amplify the signal received by the antenna;
a detector configured to detect the amplified signal;
an analog-to-digital convertor (ADC) configured to convert the detected analog signal to a digital signal; and
a wake-up controller configured to compare the digital signal with the reference value and then to generate the wake-up command according to comparison results.

5. The system of claim 4, wherein the wake-up controller includes:
at least one reference register each configured to store at least one reference value;
a shift register configured to store an output signal of the ADC;
at least one comparator configured to compare the reference value stored in the at least one reference register and a value stored in the shift register; and
a wake-up generator configured to generate at least one kind of the wake-up command according to comparison results of the at least one comparator.

6. The system of claim 1, wherein the wake-up system is composed of two or more chips each of which is separately activated and driven in response to the wake-up command.

7. The system of claim 1, wherein the wake-up detection module is further configured to adjust a sampling bit rate of the wake-up signal to 1˜4 msec according to external inputs.

8. A method for operating a wireless wake-up system, the method comprising steps of:
activating a wake-up detection module;
comparing a wireless input signal received through an antenna with a pre-stored reference value;
if the wireless input signal is equal to the reference value, determining that the input signal is a wake-up signal with a low bit rate and then generating a wake-up command corresponding to the wake-up signal; and
activating a selected module kept in an inactive state by sending the wake-up command to the selected module.

9. The method of claim 8, wherein the activated module includes a microcontroller unit (MCU).

10. The method of claim 9, further comprising at least one of steps of:
inactivating the wake-up detection module when the MCU is activated; and
activating a radio frequency (RF) receiver connected to the MCU, performing a demodulation and decoding of a wireless data signal received by the antenna in the RF receiver, and processing the decoded data signal in the RF receiver.

11. The method of claim 10, further comprising at least one of steps of:
activating the wake-up detection module when the data signal processing is completed; and
inactivating at least one of the MCU and the RF receiver.

12. The method of claim 8, wherein the step of generating the wake-up command includes:
comparing the wireless input signal with two or more reference values; and
if the wireless input signal corresponds to a particular one of the reference values, generating the wake-up command corresponding to the particular reference value.
